(19) United States
(12) Patent Application Publication
(10) Pub. No.: US 2025/0296807 A1
(43) Pub. Date: Sep. 25, 2025

(54) METHOD AND APPARATUS FOR DISPOSING OF FAULTS IN AN ELEVATOR SYSTEM

(71) Applicant: Otis Elevator Company, Farmington, CT (US)

(72) Inventors: Hongliang Tian, Shanghai (CN); Jiuming Cheng, Shanghai (CN)

(21) Appl. No.: 19/082,765

(22) Filed: Mar. 18, 2025

(30) Foreign Application Priority Data
Mar. 20, 2024 (CN) 202410323765.2

(51) Int. Cl. B66B 5/00; B66B 1/34; B66B 5/02

(52) U.S. Cl. CPC B66B 5/0031; B66B 1/3453; B66B 1/3461; B66B 5/027

(57) ABSTRACT

A method and device for disposing of a malfunction of an elevator system, an elevator system including the device, and a non-transitory computer-readable storage medium storing a computer program for implementing the method. In a method for disposing of the malfunction of the elevator system, states of a plurality of landing door safety chains are monitored. Subsequently, in response to an abnormal event associated with the landing door safety chains, a safe landing station at which a car is to be stopped is determined based on a motion state of the car. Landing door state detection devices are divided into a plurality of groups of the landing door state detection devices, and each landing door safety chain comprises one of the plurality of groups of the landing door state detection devices. The motion state of the car comprises a movement speed and a position of the car.

### FOREIGN PRIORITY

This application claims priority to Chinese Patent Application No. 202410323765.2, filed Mar. 20, 2024, and all the benefits accruing therefrom under 35 U.S.C. § 119, the contents of which in its entirety are herein incorporated by reference.

### TECHNICAL FIELD OF INVENTION

The present disclosure relates to elevator technology and, in particular, to a method and device for disposing of a malfunction of an elevator system, an elevator system comprising the device, and a non-transitory computer-readable storage medium storing a computer program for implementing the method.

### BACKGROUND OF THE INVENTION

An elevator system typically includes a plurality of door interlocking devices, each mounted on a corresponding landing door. The elevator system also includes landing door switches for detecting locked and unlocked states of the door interlocking devices. These landing door switches are connected in series with each other to form a landing door safety chain. During elevator operation, an operating signal indicative of the on-off state of the landing door safety chain is sent to an elevator control device to enable the elevator control device to operate an elevator car correctly.

In the present elevator system, the landing door safety chain is in a disconnected state when the door interlocking device is unlocked accidentally or under non-active control. In response to this event, the elevator control device stops the movement of the elevator car to reduce the safety risk. However, the elevator system is often time-consuming to service, which may result in passengers being trapped in the car for a long time.

### SUMMARY OF THE INVENTION

In accordance with an aspect of the present disclosure, there are provided a method and device for disposing of a malfunction of an elevator system, and an elevator system.

In accordance with an aspect of the present disclosure, in the provided method for disposing of the malfunction of the elevator system, states of a plurality of landing door safety chains are monitored. Subsequently, in response to an abnormal event associated with the landing door safety chains, a safe landing station at which a car is to be stopped is determined based on a motion state of the car. In the above-described method, landing door state detection devices are divided into a plurality of groups of the landing door state detection devices, and each landing door safety chain comprises one of the plurality of groups of the landing door state detection devices. In addition, the motion state of the car comprises a movement speed and a position of the car.

Optionally, in the above method, the landing door state detection device comprises a landing door switch or a landing door detection sensor.

Optionally, in the above method, one or more of the landing door state detection devices in each of the groups of the landing door state detection devices is configured to detect a state of one of a plurality of landing doors.

Optionally, in the above method, the method further comprises step of causing the car to travel to the safe landing station and step of causing the corresponding landing door and a car door of the car to be in an open state after the car stops at the safe landing station.

Optionally, the above method may further comprise causing the elevator system to enter a state of stopped operation and sending a report of occurrence of the abnormal event to a remote server or cloud.

As for the division of the groups of the landing door state detection devices, in the above method, the approach is to distribute the landing door state detection devices corresponding to a plurality of spatially continuously distributed landing stations as widely dispersed as possible among the plurality of the groups of the landing door state detection devices. Further, the landing door state detection devices corresponding to the plurality of spatially continuously distributed landing stations may be made to belong to different groups of the landing door state detection devices.

In addition to comprising one or more of the above features, the abnormal event in the above method may comprise: i) entry of the landing door safety chain into a disconnected state as a result of unlocking of a door interlocking device of the landing door under a non-active control; and ii) inability to obtain the state of the landing door safety chain.

As for the determination of the safe landing station, in the above method, the approach is to shorten a travel from the position of the car at the time of the abnormal event to the safe landing station as much as possible. Alternatively, if the car happens to stop at a certain landing station at the time of the occurrence of the abnormal event, the landing station will be determined as the safe landing station.

Optionally, in the above method, when the car is in the motion state, an emergency braking operation or a deceleration operation is performed on the car to move the car to the safe landing station.

In accordance with another aspect of the present disclosure, the provided device for disposing of the malfunction of the elevator system comprises at least one processor, at least one memory, and a computer program stored on the memory. The computer program when run on the processor will result in the following operations: monitoring states of a plurality of landing door safety chains and determining, in response to an abnormal event associated with the landing door safety chains, a safe landing station at which a car is to be stopped is determined based on a motion state such as a movement speed and a position of the car. The landing door safety chain comprises one of a plurality of groups of the landing door state detection devices divided by landing door state detection devices.

In accordance with another aspect of the present disclosure, the provided elevator system comprises a car arranged in an elevator shaft and capable of moving between a plurality of landing stations during operation, a control unit, a drive device coupled to the control unit, and a plurality of landing door safety chains. The drive device is configured to move or stop the car in response to a command from the control unit. Each landing door safety chain comprises one of a plurality of groups of the landing door state detection devices divided by landing door state detection devices. The control unit is configured to monitor states of the plurality of landing door safety chains and determine, in response to an abnormal event associated with the landing door safety chains, a safe landing station at which a car is to be stopped is determined based on a motion state such as a movement speed and a position of the car.

In accordance with a further aspect of the present disclosure, there is provided a computer-readable storage medium on which a computer program suitable for running on a processor of a terminal device is stored, the running of the computer program resulting in the steps of the method as described above being performed.

### BRIEF DESCRIPTION OF THE DRAWINGS

The above and/or other aspects and advantages of the present disclosure will be clearer and more easily understood from the following description of various aspects in conjunction with the accompanying drawings, in which the same or similar units are denoted by the same reference numerals. The accompanying drawings include:

FIG. 1 is a view of an exemplary elevator system.

FIG. 2 is a schematic block diagram of an elevator system in accordance with an embodiment of the present disclosure.

FIG. 3 is a flowchart of a method for disposing of a malfunction of an elevator system in accordance with another embodiment of the present disclosure.

FIG. 4 is a flowchart of a method for disposing of a malfunction of an elevator system in accordance with another embodiment of the present disclosure.

FIG. 5 is a schematic block diagram of a device for disposing of a malfunction of an elevator system in accordance with some other embodiments of the present disclosure.

### DETAILED DESCRIPTION OF THE INVENTION

The present disclosure is described more fully below with reference to the accompanying drawings, in which illustrative embodiments of the present disclosure are illustrated. However, the present disclosure may be implemented in different forms and should not be construed as limited to the embodiments presented herein. The presented embodiments are intended to make the disclosure herein comprehensive and complete, so as to more comprehensively convey the protection scope of the present disclosure to those skilled in the art.

In this specification, terms such as “comprising” and “including” mean that in addition to units and steps that are directly and clearly stated in the specification and claims, the technical solution of the present disclosure does not exclude the presence of other units and steps that are not directly or clearly stated in the specification and claims.

In this specification, a landing station usually refers to a location on each floor where the objects to be carried (such as passengers and machinery, etc.) enter and exit the car.

In this specification, expressions such as “a car stops at a landing station” usually refer to a case in which an elevator car arrives at a specified position on a particular floor or landing station and remains stationary there.

In this specification, a “landing door state detection device” refers to a device, equipment or component configured to detect the state of a landing door (including an open state, a closed state, etc.). Examples of the landing door state detection device include, but are not limited to, a landing door switch, a landing door detection sensor, and the like. In some embodiments, the state of each landing door may be detected utilizing a landing door state detection device; in other embodiments, it may also be detected utilizing a plurality of landing door state detection devices (which are, for example, connected together in series).

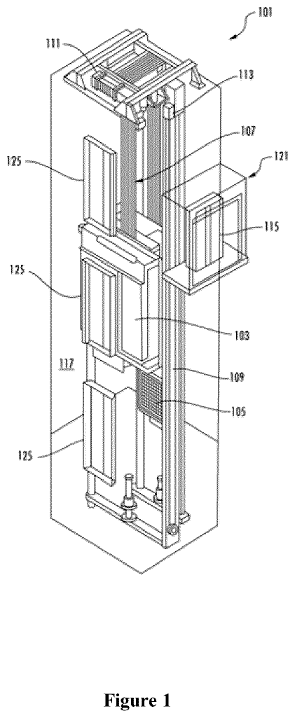

FIG. 1 is a view of an exemplary elevator system. An elevator system 101 shown in FIG. 1 includes an elevator car 103, a counterweight 105, a tensioning component 107, a guide rail (or rail system) 109, a unit (or unit system) 111, a position reference system 113, and an electronic elevator controller (controller) 115. The controller 115 may be a processor-based device that executes a program to perform the operations described herein. The elevator car 103 and the counterweight 105 may be connected to each other via the tensioning component 107. The tensioning component 107 may include or be configured as, for example, a rope, a steel cable, and/or a coated steel strip. The counterweight 105 is configured to balance a load of the elevator car 103 and is configured to assist in moving the elevator car 103 within an elevator shaft (or shaft) 117 and along the guide rail 109 in opposite directions relative to the counterweight 105 simultaneously.

The tensioning component 107 may engage the unit 111, the unit 111 may be part of a header structure of the elevator system 101. The unit 111 is configured to control movement between the elevator car 103 and the counterweight 105. The position reference system 113 may be mounted on a fixed portion at the top of the elevator shaft 117, such as on a support member or guide rail, and may be configured to provide a position signal related to the position of the elevator car 103 within the elevator shaft 117. In other embodiments, the position reference system 113 may be mounted directly to a moving assembly of the unit 111, or may be located in other locations and/or configurations as known in the art. The position reference system 113 may be any device or mechanism for monitoring the position of the elevator car and/or the counterweight as is known in the art. As may be appreciated by those skilled in the art, the position reference system 113 includes, for example, but is not limited to, an encoder, a sensor, or other systems, and may implement various sensing such as velocity sensing, absolute position sensing, and the like.

As shown, the controller 115 is located in a controller compartment 121 of the elevator shaft 117 and is configured to control operation of the elevator system 101 (and in particular, the elevator car 103). For example, the controller 115 may provide a drive signal to the unit 111 to control acceleration, deceleration, leveling, stopping, and the like of the elevator car 103. The controller 115 may also be configured to receive the position signal from the position reference system 113 or any other desired position reference device. While moving up or down along the guide rail 109 within the elevator shaft 117, the elevator car 103 may stop at one or more landing stations 125 as controlled by the controller 115. Although shown in the controller compartment 121, those skilled in the art will appreciate that the controller 115 may be located and/or configured at other places or locations within the elevator system 101. In an embodiment, the controller may be remotely located or located in a cloud.

The unit 111 may include a motor or similar drive mechanism. According to embodiments of the present disclosure, the unit 111 is configured to include an electrically driven motor. A power source for the motor may be any power source, including a power grid, the power source being supplied to the motor in combination with other components. The unit 111 may include a traction pulley, the traction pulley transmitting force to the tensioning component 107 to move the elevator car 103 within the elevator shaft 117.

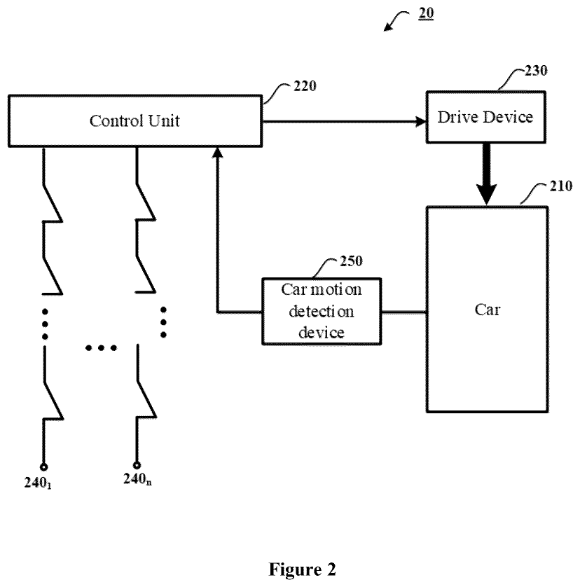

FIG. 2 is a schematic block diagram of an elevator system in accordance with an embodiment of the present disclosure. The elevator system has a malfunction disposal function as will be described in detail below.

As shown in FIG. 2, an elevator system 20 includes a car 210, a control unit 220 (which may be, for example, the controller 115 of FIG. 1), a drive device 230 (which includes, for example, the unit 111 of FIG. 1), and a plurality of landing door safety chains 240₁ to 240ₙ. Optionally, a car motion detection device 250 (e.g., the position reference system 113 of FIG. 1) may also be considered as a constituent unit of the elevator system.

Exemplarily, it is assumed that there are m landing stations (each of which may be, for example, the landing stations 125 shown in FIG. 1) available for the car 210 to stop at, and accordingly, each of the landing stations has respective landing door switches (these are hereinafter referred to as K₁ to Kₘ). In some specific implementations, the landing door switches K₁ to Kₘ are divided into n groups of the landing door switches GK₁ to GKₙ, and each group of the landing door switches is used to construct one of the plurality of landing door safety chains 240₁ to 240ₙ. Specifically, for the i-th group of the landing door switches GKᵢ, the landing door switches contained therein are connected in series with each other to construct the ith landing door safety chain 240ᵢ. Referring to FIG. 2, each landing door safety chain is connected to the control unit 220 to provide the control unit 220 with an operating signal regarding the state (closed and open) of the landing door safety chain.

Continuing to refer to FIG. 2, the control unit 220 is coupled with the landing door safety chains 240₁ to 240ₙ, which are configured to monitor the states of the landing door safety chains. In case of normal operation of the elevator system, after the car stops at the destination floor or landing station, a door interlocking device of the landing door will change from the locked state to the unlocked state. At this time, the landing door will be opened and the corresponding landing door switch will enter the opened state, and result in the disconnected state of the landing door safety chain in which it is located. On the other hand, a malfunction of the elevator system may also cause the door interlocking device to enter the unlocked state (at which point the landing door is in an open state), and accordingly, the landing door safety chain will be in a disconnected state. Such unlocking under non-active control will put passengers in great danger, especially when the car is in motion or in a non-stop position.

In some specific embodiments, the event that the door interlocking device enters the unlocked state under non-active control is included in the abnormal events associated with the landing door safety chains. Accordingly, the control unit 220 will perform the malfunction disposition operations to be described below in response to the occurrence of this abnormal event.

In other specific embodiments, the event that the state of the landing door safety chain cannot be obtained (e.g., stemming from damage to the line connecting the controller to the landing door safety chain, etc.) is further included in the abnormal events associated with the landing door safety chains.

It should be noted that the above examples of abnormal events are merely exemplary. In actual applications, other types of events may also be included in the abnormal events according to the special needs of the scenario.

In the elevator system shown in FIG. 2, the control unit 220 is also configured to determine a safe landing station or floor at which the car is to be stopped based on a motion state of the car 210 (e.g., a movement speed and a position of the car, etc.) upon occurrence of the abnormal event associated with the landing door safety chains. That is, unlike the processing method that immediately stops the movement of the car when the abnormal event occurs, in the elevator system shown in FIG. 2, a landing station having a high stopping safety is selected for the car, and then the control unit 220, with the aid of the drive device 230, causes the car 210 to move to the safe landing station, and causes the landing door to open after the car stops at the safe landing station.

In some specific implementations, the control unit 220 may communicate with the car motion detection device 250 (e.g., the position reference system 113 of FIG. 1) to obtain the position and movement speed of the car. Exemplarily, the absolute position of the elevator car within the elevator shaft may be measured by the position reference system 113 and output to the control unit 220, and the speed of the elevator car may be calculated based on the absolute position and the correlation time of the absolute position. Such calculations may be performed by the position reference system 113 and provided to the control unit 220, or may also be performed by the control unit 220.

Further, in the elevator system shown in FIG. 2, the control unit 220 is also configured to cause the elevator system to enter a state of stopped operation after the car stops at the safe landing station and the landing door is opened. Optionally, the control unit 220 is further configured to send a report of occurrence of the abnormal event to a remote server or cloud after or at the same time as causing the elevator system to enter the state of stopped operation. Alternatively, the control unit 220 may also be configured to send a report of occurrence of the abnormal event to the remote server or the cloud when the occurrence of the abnormal event associated with the landing door safety chains is monitored.

In the embodiment shown in FIG. 2, functions such as abnormal event monitoring, safe landing station determination, elevator system control (e.g., control of the position and speed of the elevator car), and abnormal event reporting are performed by a single control unit, but this implementation is not necessary and unique. In other embodiments, functions such as abnormal event monitoring and safe landing station determination may be separated and implemented using a specialized safety controller or safety control unit, such as a Programmable Electronic System in Safety Related Applications for Lifts (PESSRAL) system.

As described above, the landing door switches are grouped and each group of the landing door switches corresponds to one of the plurality of landing door safety chains, so that the occurrence of the abnormal event within the landing door safety chain 240ᵢ implies that any of the landing door switches within the corresponding group of the landing door switches GKᵢ may be in an open state (or any of the corresponding door interlocking devices may have been incorrectly unlocked). In the above sense, all landing stations corresponding to the landing door safety chain 240ᵢ where the abnormal event occurred are considered to be implicated or involved in the abnormal event. On the other hand, in the current example, the landing stations corresponding to the landing door safety chains (e.g., landing door safety chains 240₁ to 240ᵢ₋₁ and 240ᵢ₊₁ to 240ₙ) where the abnormal event did not occur may all be included in the set of landing stations having a high stopping safety (which set is also referred to hereinafter as the set of safe landing station candidates).

It should be noted that the inclusion of landing stations not involved in the abnormal event in the set of safe landing station candidates is only an exemplary approach. Optionally, the set of safe landing station candidates may be limited to a smaller set by adding one or more filtering conditions. Example filtering conditions may be, for example, that among the landing stations that are not involved in the current abnormal event, only landing stations along the current movement direction of the car are included in the set of safe landing station candidates (e.g., assuming that the current movement direction of the car is upward, only landing stations above it that are not involved in the abnormal event belong to the set of safe landing station candidates; or that among the landing stations that are not involved in the current abnormal event, landing stations that are involved in abnormal events many times in history or landing doors that have not replaced their door interlocking devices for a long time are excluded from the set of safe landing station candidates.

The safe landing station to be stopped may be selected from the set of safe landing station candidates based on various strategies. In some specific embodiments, a so-called “short path strategy” may be used to determine the safe landing station, i.e. the selected safe landing station should shorten a path from the position of the car at the time of the abnormal event to the selected safe landing station as much as possible. It should be noted that “shortening as much as possible” is a practical and feasible approach. Specifically, due to braking capacity constraints, it is not always possible to ensure that the car always stops at the landing station closest to its position when the abnormal event occurs. Therefore, when selecting a safe landing station, in addition to considering the position of the car at the time of the abnormal event, it is also necessary to consider the movement speed of the car (which, together with the braking capacity and other factors, determines the car's shortest braking distance).

In other specific implementations, for a car that is in a stationary state, if it happens to stop at a certain landing station when the abnormal event occurs, that landing station is determined to be a safe landing station, regardless of whether or not it was involved in the abnormal event.

In further specific embodiments, for a car that is in a stationary state, if it happens to stop at a certain landing station when the abnormal event occurs, the landing station is determined to be a safe landing station only if the landing station is a landing station that is not involved in the abnormal event, otherwise, for example, the short travel strategy as described above may be used to select the safe landing station.

The grouping method of the landing door switches is described further below.

Taking m (m>1) landing door switches being grouped into n (m>n>1) groups of landing door switches as an example, the landing door switches and the groups of landing door switches are herein denoted as K₁ to Kₘ and GK₁ to GKₙ, respectively, wherein it is assumed that, for the purpose of convenience of description, the serial numbers 1 to m of the landing door switches correspond one-to-one with the first to m-th floors, or equivalently, the serial numbers 1 to m of the landing door switches correspond one-to-one with the landing stations LS₁ to LSₘ of the first to m-th floors.

In some specific implementations, a so-called “decentralized grouping” strategy or method is used to group the landing door switches. Specifically, the landing door switches K₁, K₁₊ₙ, K₁₊₂ₙ . . . may be grouped into the group of the landing door switches GK₁, the landing door switches K₂, K₂₊ₙ, K₂₊₂ₙ . . . may be grouped into the group of the landing door switches GK₂, and so on for the other landing door switches.

For the case where m can be divided by n, the m landing door switches are exactly equally divided into n groups of the landing door switches, and the number of landing door switches within each group of the landing door switches is m/n. As a result, n landing door switches corresponding to spatially continuously distributed landing stations (e.g., the landing door switches (K₁, K₂ . . . . Kₙ), (Kₙ₊₁, Kₙ₊₂ . . . . K₂ₙ), . . . , (Kₘ₋ₙ₊₁, Kₘ₋ₙ₊₂ . . . . Kₘ) in the present example) are maximally dispersed and distributed among the groups of landing door switches GK₁ to GKₙ.

For the case where m cannot be divided by n, assuming that the remainder of m divided by n is p, there are (m-p) landing door switches are exactly equally divided into n groups of the landing door switches. For the remaining p landing door switches Kₘ₋ₚ₊₁ to Kₘ, the division method similar to the above may still be used. For example, the landing door switches Kₘ₋ₚ₊₁ to Kₘ may be assigned to p groups of the landing door switches among the groups of landing door switches GK₁ to GKₙ and ensure that no two landing door switches in the landing door switches Kₘ₋ₚ₊₁ to Kₘ are assigned to the same group of landing door switches. As a result, the landing door switches corresponding to a plurality of spatially continuously distributed landing stations may likewise be distributed as dispersed as possible among the groups of landing door switches GK₁ to GKₙ.

Compared with the method of connecting the landing door switches in series to construct a single landing door safety chain, the method of grouping the landing door switches and thereby constructing a plurality of landing door safety chains can provide more abundant malfunction location information. Specifically, in the former method, the disconnection of the landing door safety chain means that there is a possibility that any one of the door interlocking devices may have been mistakenly unlocked; in the latter method, by contrast, the disconnection of one or more of the landing door safety chains (not all of them) means that there is a possibility that only part of the door interlocking devices may have been mistakenly unlocked, thus providing additional information about the landing door switches or the door interlocking devices that are not involved in the abnormal event. This additional information can be used to obtain the set of landing stations having a high stopping safety and thus determine a safe landing station at which a car is to be stopped.

Further, the decentralized grouping method as described above will bring more benefits, such as overall shortening a travel from the position of the car at the time of the abnormal event to the safe landing station. Further description is provided below.

Exemplarily, assuming that 18 landing door switches are grouped into 3 groups of the landing door switches in the manner described above, the landing door switches K₁, K₄, K₇, K₁₀, K₁₃, and K₁₆ may be assigned to the group of the landing door switches GK₁, the landing door switches K₂, K₅, K₈, K₁₁, K₁₄, and K₁₇ may be assigned to the group of the landing door switches GK₂, and the landing door switches K₃, K₆, K₉, K₁₂, K₁₅, and K₁₈ may be assigned to the group of the landing door switches GK₃. For example, if an abnormal event occurs in the landing door safety chain corresponding to the group of the landing door switches GK₂, landing stations LS₂, LS₅, LS₈, LS₁₁, LS₁₄, and LS₁₇ corresponding to the landing door switches K₂, K₅, K₈, K₁₁, K₁₄, and K₁₇ are regarded as landing stations involved in the abnormal event. Since the landing stations that are not involved in the abnormal event are scattered throughout the entire floor, there is a high probability that a landing station that is not involved in the abnormal event is selected as a safe landing station in the vicinity of the car, regardless of the car's position.

In contrast, if the landing door switches corresponding to a plurality of spatially continuously distributed landing stations are grouped into the same group of the landing door switches (hereinafter referred to as the “centralized grouping strategy”), it is possible to significantly increase the travel from the position of the car at the time of the abnormal event to the safe landing station. Still taking the example of 18 landing door switches grouped into 3 groups of the landing door switches, under the centralized grouping strategy, the landing door switches K₁, K₂, K₃, K₄, K₅, and K₆ are assigned to the group of the landing door switches GK₁, the landing door switches K₇, K₈, K₉, K₁₀, K₁₁, and K₁₂ are assigned to the group of the landing door switches GK₂, and the landing door switches K₁₃, K₁₄, K₁₅, K₁₆, K₁₇, and K₁₈ are assigned to the group of the landing door switches GK₃. If an abnormal event occurs in the landing door safety chain corresponding to the group of the landing door switches GK₂ at this time and the car travels upwards to the position between the landing stations LS₆ and LS₇, only the landing stations LS₁₃, LS₁₄, LS₁₅, LS₁₆, LS₁₇ and LS₁₈ may be included in the set of safe landing station candidates, which means that the car needs to pass through at least 6 landing stations to reach the safe landing station. Due to the possibility that the door interlocking device being mistakenly unlocked may not be an isolated component failure event, an increase in travel will put passengers in a more dangerous situation.

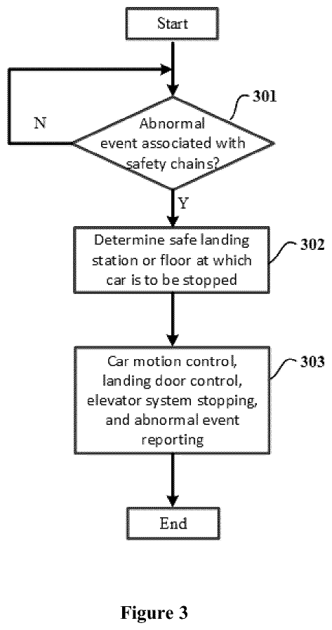

FIG. 3 is a flowchart of a method for disposing of a malfunction of an elevator system in accordance with another embodiment of the present disclosure. The method described below may be implemented by various devices, which include, for example, but are not limited to, controllers (e.g., the controller 115 in FIG. 1 and/or the controller 220 in FIG. 2) and safety controllers in the elevator system, etc., which will be collectively referred to hereinafter as devices or control devices for disposing of the malfunction of the elevator system.

The method shown in FIG. 3 begins at step 301. In this step, the control device monitors the states of a plurality of landing door safety chains (e.g., landing door safety chains 240₁ to 240ₙ in FIG. 2) to determine whether an abnormal event associated with the landing door safety chains has occurred, and if so, goes to step 302, otherwise continues with step 301 (e.g., in a periodic manner) to determine the states of the landing door safety chains at subsequent moments.

In this embodiment, similar to the previous embodiment, the landing door switches are also divided into a plurality of groups of the landing door switches, and the landing door switches within each group of the landing door switches are connected in series with each other to construct a corresponding landing door safety chain. The specific manner in which the landing door switches are divided is described in detail above and will not be repeated herein.

Exemplarily, two ends of each landing door safety chain are connected to a power supply and a control device respectively. In the closed state, an operating signal input to the control device is a high level signal, while in the disconnected state, the operating signal is a low level signal, i.e., the closed state and the disconnected state of the landing door safety chain may be determined based on the level of the operating signal.

In some specific implementations, in addition to classifying the disconnection of the landing door safety chain due to the door interlocking device being mistakenly unlocked under non-active control as an abnormal event, inability to obtain the state of the landing door safety chain is also classified as an abnormal event.

After step 301, the process shown in FIG. 3 proceeds to step 302. In this step, the control device determines a safe landing station or floor at which the car is to be stopped based on a motion state of the car (e.g., a movement speed and a position of the car, etc.). The specific determination of the safe landing station has been described in detail above with reference to FIG. 2, and will not be repeated here.

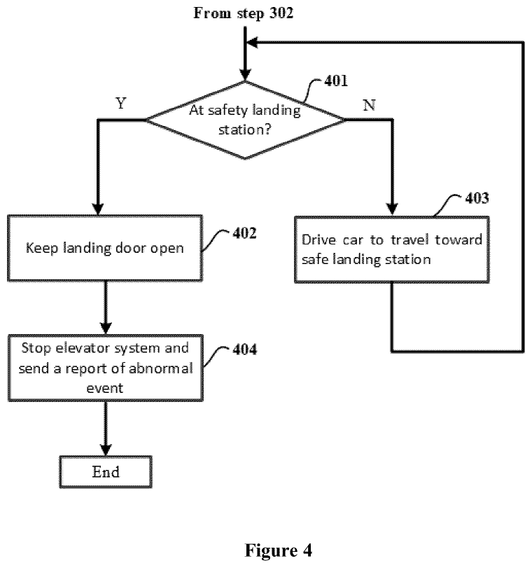

Subsequently, proceeding to step 303, the control device will perform the operations shown in FIG. 4 (including, for example, car motion control, landing door control, elevator system stopping, and abnormal event reporting, etc.). It should be noted that when functions such as abnormal event monitoring and safe landing station determination are left to a separate safety controller (e.g., a Programmable Electronic System in Safety Related Applications for Lifts (PESSRAL) system), steps 301, 302 and step 303 have different execution bodies, i.e., steps 301, 302 may be executed by the safety controller, while step 303 may utilize a controller that controls the elevator system (e.g., controller 115 in FIG. 1) to perform. Conversely, when functions such as abnormal event monitoring, safe landing station determination, elevator system control, and abnormal event reporting are integrated within a single control unit, steps 301 to 303 may have the same execution body (e.g., control unit 220 in FIG. 2).

FIG. 4 is a flowchart of a method for disposing of a malfunction of an elevator system in accordance with another embodiment of the present disclosure.

The flow shown in FIG. 4 begins at step 401, which may for example be succeeded by step 302 in FIG. 3. In step 401, the control device determines whether at the current moment the car has stopped at a safety landing station, and if it has, proceeds to step 402, otherwise, proceeds to step 403.

In step 402, the control device will keep the landing door and the car door open for a set length of time (e.g., 5 minutes), or keep the landing door and the car door open until it is determined that there is no object to be carried in the car (e.g., it is determined based on an image of the interior of the car captured by an image acquisition device).

After step 402, the process shown in FIG. 4 moves to step 404. In this step, the control device causes the elevator system to enter a state of stopped operation and sends a report of the occurrence of an abnormal event to the remote server or the cloud. In some specific implementations, the report on the abnormal event may contain information such as the landing door safety chain involved in the abnormal event and the time when the abnormal event occurred.

On the other hand, in another branch step 403 of step 401, the control device, for example, generates a control command based on a movement speed and a position of the car and sends the control command to a drive mechanism (e.g., the unit 111 in FIG. 1) to drive the car to travel toward the safe landing station. In some specific implementations, the control device may perform an emergency braking operation or a deceleration operation on the car via the drive mechanism. Exemplarily, when the car is moving faster and the current position is closer to the landing station involved in the abnormal event, the control device may send an emergency brake command to the drive mechanism to allow the car to pass the landing station involved in the abnormal event at a lower speed. As another example, if the distance between the current position and the landing station involved in the abnormal event is greater than the braking distance, the control device may send a deceleration command to the drive mechanism to enable the car to stop at a safe landing station located before the landing station involved in the abnormal event.

After executing step 403, the process shown in FIG. 4 moves to step 401 to determine whether the car has stopped at the safe landing station. Steps 401 and 403 constitute a car motion control process whose control objective is to cause the car to stop at the determined safe landing station.

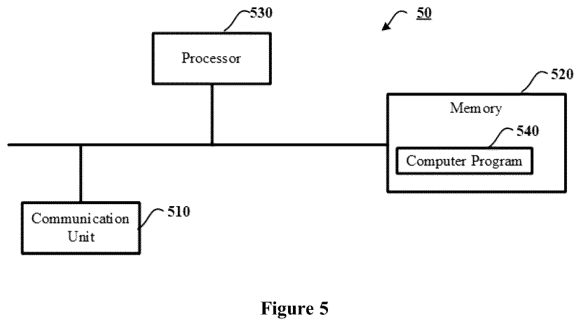

FIG. 5 is a schematic block diagram of a device for disposing of a malfunction of an elevator system in accordance with some other embodiments of the present disclosure. The device shown in FIG. 5 may be used, for example, to implement a controller (e.g., controller 115 in FIG. 1 and/or the controller 220 in FIG. 2) or a safety controller, etc., in an elevator system.

As shown in FIG. 5, a device 50 comprises a communication unit 510 (e.g., a wired or wireless network card), one or more memories 520 (e.g., non-volatile memories such as flash memory, ROM, hard disk drive, magnetic disk, optical disk, etc.), one or more processors 530, and a computer program 540.

The communication unit 510 serves as a communication interface configured to receive control commands and data from an external device (e.g., other units of the elevator system (e.g., the unit 111, the position reference system 113 in FIG. 1, and the landing door safety chains 240₁ to 240ₙ in FIG. 2), etc.) or a network (e.g., the Internet and a wireless local area network, etc.) as well as to send to the external device or the network control commands and data generated at the device 50.

The memory 520 stores the computer program 540 that may be executed by the processor 530. In addition, the memory 520 may store data generated by the processor 530 in executing the computer program 540 and data received from the external device via the communication unit 510 (e.g., a movement speed and a position of the car, the landing door safety chain involved in the abnormal event, and the moment at which the abnormal event occurred, etc.).

The processor 530 is configured to run the computer program 540 stored on the memory 520 and perform access operations to the memory 520.

The computer program 540 may include computer instructions for implementing various functions and operations described with the aid of FIGS. 2 to 4, enabling the functions and operations of these to be implemented by running the computer program 540 on the processor 530.

It should be noted that in the various embodiments described above with the aid of the accompanying drawings, the landing door switch is used as an example of a landing door state detection device. However, this is merely exemplary, and a person skilled in the art will be able to recognize, after reading the present disclosure, that in the embodiments described with the aid of the accompanying drawings, it is also feasible to replace the landing door switch with other devices such as a landing door detection sensor.

It should also be noted that in the embodiments described above with the aid of FIGS. 2-5, the state of each landing door is detected by a landing door state detection device (e.g., a landing door switch). However, this is merely exemplary, and a person skilled in the art will be able to recognize, after reading the present disclosure, that the embodiments described above with the aid of the accompanying drawings may also be applied to situations in which the state of each landing door is detected by a plurality of landing door state detection devices.

Those skilled in the art will appreciate that various illustrative logical blocks, modules, circuits, and algorithm steps described herein may be implemented as electronic hardware, computer software, or combinations of both.

To demonstrate this interchangeability between the hardware and software, various illustrative components, blocks, modules, circuits, and steps have been described above generally in terms of their functionality. Whether such functionality is implemented in hardware or software depends on the particular application and design constraints imposed on the overall system. Those skilled in the art may implement the described functionality in changing ways for the particular application. However, such implementation decisions should not be interpreted as causing a departure from the scope of the present disclosure.

Although only a few of the specific embodiments of the present disclosure have been described, those skilled in the art will appreciate that the present disclosure may be embodied in many other forms without departing from the spirit and scope thereof. Accordingly, the examples and implementations shown are to be regarded as illustrative and not restrictive, and various modifications and substitutions may be covered by the present disclosure without departing from the spirit and scope of the present disclosure as defined by the appended claims.

The embodiments and examples presented herein are provided to best illustrate embodiments in accordance with the present technology and its particular application, and to thereby enable those skilled in the art to implement and use the present disclosure. However, those skilled in the art will appreciate that the above description and examples are provided for convenience of illustration and example only. The presented description is not intended to cover every aspect of the present disclosure or to limit the present disclosure to the precise form disclosed.

What is claimed is:

1. A method for disposing of a malfunction of an elevator system, comprising:
A. monitoring states of a plurality of landing door safety chains, wherein landing door state detection devices are divided into a plurality of groups of the landing door state detection devices, and each landing door safety chain comprises one of the plurality of groups of the landing door state detection devices; and
B. determining, in response to an abnormal event associated with the landing door safety chains, a safe landing station at which a car is to be stopped based on a motion state of the car, wherein the motion state comprises a movement speed and a position of the car.

2. The method of claim 1, wherein the landing door state detection device comprises a landing door switch or a landing door detection sensor.

3. The method of claim 1, wherein one or more of the landing door state detection devices in each of the groups of the landing door state detection devices is configured to detect a state of one of a plurality of landing doors.

4. The method of claim 1, wherein further comprising:
C. causing the car to travel to the safe landing station;
D. causing a corresponding landing door and a car door of the car to be in an open state after the car stops at the safe landing station.

5. The method of claim 1, wherein further comprising:
E. causing the elevator system to enter a state of stopped operation and sending a report of occurrence of the abnormal event to a remote server or cloud.

6. The method of claim 1, wherein the groups of the landing door state detection devices are divided in such a manner that the landing door state detection devices corresponding to a plurality of spatially continuously distributed landing stations are distributed as widely dispersed as possible among the plurality of the groups of the landing door state detection devices.

7. The method of claim 6, wherein the groups of the landing door state detection devices are divided in such a manner that the landing door state detection devices corresponding to a plurality of spatially continuously distributed landing stations are distributed to different groups of the landing door state detection devices.

8. The method of claim 1, wherein the abnormal event comprises: i) entry of the landing door safety chain into a disconnected state as a result of unlocking of a door interlocking device of the landing door under a non-active control; and ii) inability to obtain the state of the landing door safety chain.

9. The method of claim 4, wherein the method of determining the safe landing station is to shorten as much as possible a path from the position of the car at the time of the abnormal event to the safe landing station.

10. The method of claim 1, wherein the method of determining the safe landing station is to determine the landing station as the safe landing station if the car happens to stop at a certain landing station at the time of the occurrence of the abnormal event.

11. The method of claim 4, wherein in step C, when the car is in the motion state, an emergency braking operation or a deceleration operation is performed on the car to move the car to the safe landing station.

12. A device for disposing of a malfunction of an elevator system, comprising:
at least one processor;
at least one memory; and
a computer program stored on the memory which when run on the processor causes the following operations:
A. monitoring states of a plurality of landing door safety chains, wherein landing door state detection devices are divided into a plurality of groups of the landing door state detection devices, and each landing door safety chain comprises one of the plurality of groups of the landing door state detection devices; and
B. determining, in response to an abnormal event associated with the landing door safety chains, a safe landing station at which a car is to be stopped based on a motion state of the car, wherein the motion state comprises a movement speed and a position of the car.

13. The device of claim 12, wherein the landing door state detection device comprises a landing door switch or a landing door detection sensor.

14. The device of claim 12, wherein one or more of the landing door state detection devices in each of the groups of the landing door state detection devices is configured to detect a state of one of a plurality of landing doors.

15. The device of claim 12, wherein the computer program which when run on the processor further causes the following operations:
C. causing the car to travel to the safe landing station;
D. causing a corresponding landing door and a car door of the car to be in an open state after the car stops at the safe landing station.

16. The device of claim 12, wherein the computer program which when run on the processor further causes the following operations:
E. causing the elevator system to enter a state of stopped operation and sending a report of occurrence of the abnormal event to a remote server or cloud.

17. The device of claim 12, wherein the groups of the landing door state detection devices are divided in such a manner that the landing door state detection devices corresponding to a plurality of spatially continuously distributed landing stations are distributed as widely dispersed as possible among the plurality of the groups of the landing door state detection devices.

18. The device of claim 12, wherein the groups of the landing door state detection devices are divided in such a manner that the landing door state detection devices corresponding to a plurality of spatially continuously distributed landing stations are distributed to different groups of the landing door state detection devices.

19. The device of claim 12, wherein the abnormal event comprises: i) entry of the landing door safety chain into a disconnected state as a result of unlocking of a door interlocking device of the landing door under a non-active control; and ii) inability to obtain the state of the landing door safety chain.

20. The device of claim 15, wherein the computer program which when run on the processor causes the safe landing station to be determined in such a way as to shorten as much as possible a path from the position of the car at the time of the abnormal event to the safe landing station.

21. The device of claim 12, wherein the computer program which when run on the processor causes the safe landing station to be determined in such a way as to determine the landing station as the safe landing station if the car happens to stop at a certain landing station at the time of the occurrence of the abnormal event.

22. The device of claim 12, wherein the device is an elevator controller of the elevator system or a safety controller independent of the elevator controller.

23. The device of claim 15, wherein the device is an elevator controller of the elevator system, and wherein the computer program which when run on the processor causes the car to move the car to the safe landing station in operation C by performing an emergency braking operation or a deceleration operation on the car when the car is in the motion state.

24. An elevator system comprising:
a car arranged in an elevator shaft and capable of moving between a plurality of landing stations during operation;
a control unit;
a drive device coupled to the control unit, the drive device being configured to move or stop the car in response to a command from the control unit; and
a plurality of landing door safety chains, wherein landing door state detection devices are divided into a plurality of groups of the landing door state detection devices, and each landing door safety chain comprises one of the plurality of groups of the landing door state detection devices,
wherein the control unit is configured to:
A. monitor states of the landing door safety chains; and
B. determine, in response to an abnormal event associated with the landing door safety chains, a safe landing station at which a car is to be stopped based on a motion state of the car, wherein the motion state comprises a movement speed and a position of the car.

25. A non-transitory computer-readable storage medium, the computer-readable storage medium having instructions stored therein, characterized in that the method of claim 1 is implemented by executing the instructions by a processor.
